(19) United States
(12) Patent Application Publication
(10) Pub. No.: US 2010/0150787 A1
(43) Pub. Date: Jun. 17, 2010

(54) DISPLAY FILTER AND DISPLAY DEVICE REMOVING INDOOR AIR POLLUTANTS

(75) Inventors: Moon Jin Choi, ChungCheongNam-Do (KR); Ji Young Kim, ChungCheongNam-Do (KR); Dae Chul Park, ChungCheongNam-Do (KR); Hwa Yeon Lee, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/638,068

(22) Filed: Dec. 15, 2009

(30) Foreign Application Priority Data
Dec. 17, 2008 (KR) 10-2008-0128328

(51) Int. Cl. B01D 50/00

(52) U.S. Cl. 422/122; 55/385.6

(57) ABSTRACT

A display filter for a display device having a display module includes a base substrate disposed in front of the display module, at least one optical filter layer layered on the base substrate, and an indoor air purification layer layered on an outwardly exposed side of the display filter and removing indoor air pollutants.

### CROSS-REFERENCE TO RELATED APPLICATION

This application claims the benefit of Korean Patent Application No. 2008-0128328 filed on Dec. 17, 2008, in the Korean Intellectual Property Office, the disclosure of which is incorporated herein by reference.

### BACKGROUND OF THE INVENTION

1. Field of the Invention

The present invention relates to a display filter and a display device which can remove indoor air pollutants.

2. Description of the Related Art

Recently, there are many researches into harmful indoor air pollutants and indoor environmental management due to sick house syndrome, a desire for well-being, and so forth. Sick house syndrome is a phenomenon that causes symptoms such as headache, fatigue, dyspnea, asthma, dermatitis, and so on, by chemical compounds generated in a newly built or renovated house. The chemical compounds include carcinogens such as benzene, toluene, chloroform, acetone, and formaldehyde.

As one solution for sick house syndrome, ventilation helps to improve indoor air quality. However, continual effort or a room air cleaner is required to ventilate a closed space.

As another solution for sick house syndrome, a photocatalyst applied onto construction materials can oxidize and dissolve pollutants which are in contact with, or in the vicinity of the photocatalyst. A photocatalyst is a substance that makes catalysis happen when it is exposed to light. Semiconductor, chromatophore, chlorophyll, etc are examples of a photocatalyst.

It is well known that titanium dioxide (TiO2), which is representative of a photocatalyst, can destroy toxic or malodorous chemical compounds and harmful bacteria by using strong oxidization which occurs on its surface when it absorbs sufficient light energy. However, since titanium dioxide needs to absorb sufficient light energy, it takes a long time to attain a desired effect.

Thus, it is required to develop new solutions for sick house syndrome.

### SUMMARY OF THE INVENTION

The present invention has been made to solve the foregoing problems with the related art, and an object of the present invention is to provide a display filter and a display device which can remove indoor air pollutants.

To achieve the above object, the present invention provides a display filter including: a base substrate disposed in front of a display module, at least one optical filter layer layered on the base substrate, and an indoor air purification layer layered on an outwardly exposed side of the display filter and removing indoor air pollutants.

In another aspect, the present invention provides a display device including the display filter.

Since the display filter and the display device according to the present invention includes the indoor air purification layer, they can function as an optical filter and at the same time, can dissolve indoor air pollutant materials and various harmful organic matters such as microbes, bacteria, fungi, viruses, and the like.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross sectional view schematically illustrating a first display device with a display filter according to a first embodiment of the present invention.

FIG. 2 is a cross sectional view schematically illustrating a second display device with a display filter according to a second embodiment of the present invention.

### DETAILED DESCRIPTION OF THE EXEMPLARY EMBODIMENT

The present invention is described more fully hereinafter with reference to the accompanying drawings, in which exemplary embodiments of the present invention are shown. This invention may, however, be embodied in many other forms and should not be construed as being limited to the exemplary embodiments set forth herein.

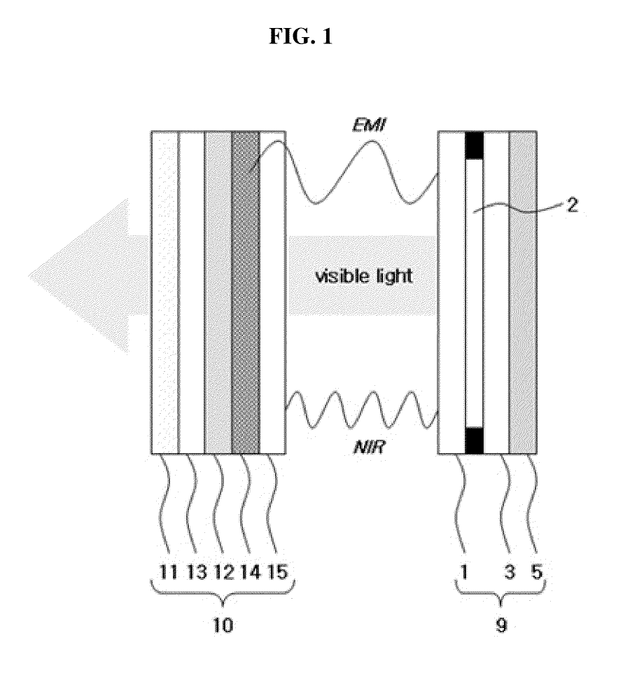

FIG. 1 is a cross sectional view schematically illustrating a first display device with a display filter according to a first embodiment of the present invention.

The first display device illustrated in FIG. 1 may be a PDP (Plasma Display Panel) device. The PDP device includes a discharge cell 2 between a first plate 1 and a second plate 3. A driving circuit board 5 is mounted on the back of the second plate 3. The discharge cell 2 is filled with a discharge gas such as Ne or Xe. The inner wall of the discharge cell 2 is coated with a fluorescent material. When alternating voltage is applied into the discharge cell 2, the discharge gas produces ultraviolet rays, the produced ultraviolet rays excite the fluorescent material, and then the excited fluorescent material emits visible light. The PDP emits visible light, plus electromagnetic waves, NIR (Near Infrared Rays), and orange color light within a wavelength range of 580 to 600 nm which deteriorates color purity.

Referring to FIG. 1, the display filter 10 used for the PDP device is disposed in front of a display module 9. The display filter 10 of the present invention includes an indoor air purification layer 11, a base substrate 12, and optical filter layers, that is, an anti-reflection film 13, an electromagnetic wave blocking film 14, or a near infrared ray blocking film 15.

The indoor air purification layer 11 dissolves air pollutants in a closed space where the PDP device is installed. The indoor air purification layer 11 includes a photocatalyst compound that makes catalysis happen when the photocatalyst compound is exposed to natural light, light emitted from an indoor lamp, or light emitted from the display module 9. For example, the photocatalyst compound may include at least one of titanium oxide, zinc oxide, cadmium sulfide, zirconium oxide, tin oxide, vanadium oxide, tungsten trioxide, and strontium titanate.

The photocatalyst compound contained in the indoor air purification layer 11 can kill or remove any bacteria, fungi, or viruses. For example, when a titanium dioxide crystal absorbs sufficient light energy, an electron is promoted to the conduction band, and a positive hole is created in the valence band. This “electron-hole pair” generates hydroxyl radicals and superoxide radicals, which are capable of oxidizing all organic matters on the surface of the titanium dioxide crystal into CO₂ and H₂O.

Also, the indoor air purification layer 11 can further include an adsorbent material which adsorbs toxic or malodorous pollutants in the atmosphere. The adsorbent material may include at least one of activated carbon and zeolite. Zeolites are microporous crystalline solids with well-defined structures. Generally they contain silica and alumina in their framework and cations, water molecules, or other molecules within their pores.

Also, the indoor air purification layer 11 can further include an antimicrobial material which destroys or prevents the growth of harmful microbes. The antimicrobial material can be made of a metal particle such as silver, cooper, or the like. The metal particle such as silver or cooper can improve efficiency of electric charge separation in the photocatalyst particle as well as antimicrobial effect.

The base substrate 12 supports optical filter layers such as an anti-reflection film 13, an electromagnetic wave blocking film 14, and a near infrared ray blocking film 15. The base substrate 12 is preferably a transparent substrate. For example, the transparent substrate can be made of heat strengthened glass, polymer resin, etc. The transparent polymer resin can be Poly-Ethylene-Terephthalate (PET), Acryl, Poly-carbonate (PC), Urethane Acrylate, Polyester, Epoxy Acrylate, Brominated Acrylate, Poly-Vinyl Chloride (PVC), etc.

The anti-reflection film 13 prevents external light, which is incident from a direction of a viewer, from being reflected again towards the outside and improves a contrast ratio of the PDP device. The anti-reflection film 13 can be embodied in the form of a single film made of fluorine-based polymer resin, magnesium fluoride, or silicon-based resin with a refractive index of 1.5 or less, preferably 1.4 or less in a visible light range. The anti-reflection film 13 can have a thickness of e.g. a quarter (¼) of a wavelength.

Also, the anti-reflection film 13 can be embodied in the form of a multilayered film in which thin films made of an inorganic compound such as metal oxide, fluoride, silicide, boride, carbide, nitride, sulfide, etc. or an organic compound such as silicon-based resin, acryl resin, fluoride-based resin, etc., which have different refractive indices, are multi-stacked.

The electromagnetic wave blocking film 14 blocks electromagnetic waves which are emitted from the display module 9 and have a harmful effect on the human body. The electromagnetic wave blocking film 14 can be embodied in the form of a conductive mesh film or a multilayered transparent conductive film in which a metal thin film and a transparent thin film with a high refractive index are stacked.

For example, the metal thin film can be made of gold, silver, cooper, palladium, or the like and the transparent thin film with a high refractive index can be made of indium oxide, tin oxide, zinc oxide, or the like.

The multilayered transparent conductive film has a function of blocking near infrared rays, as well. Accordingly, in case that the multilayered transparent conductive film is used as the electromagnetic wave blocking film 14, the display filter 10 of the present invention can block near infrared rays as well as electromagnetic waves without a separate near infrared ray blocking film.

The near infrared ray blocking film 15 blocks near infrared rays which can cause malfunction of electric home appliances such as a remote controller or a wireless phone. The near infrared ray blocking film 15 may include a near infrared ray absorbing material. For example, the near infrared ray absorbing material may be selected from a mixture colorant of a nickel dithiol type colorant and a di-immonium type colorant, a composite colorant containing copper ion and zinc ion, a cyanine type colorant, an anthraquinone type colorant, a squarylium type colorant, an azomethine type colorant, an azo type colorant, or a benzylidene type colorant.

Usually, the PDP device has a drawback that orange color is disadvantageously added to light emitted from the display module 9. Although not illustrated in FIG. 1, the display filter 10 of the present invention may further include a color compensating film to selectively absorb light in a specific range of a wavelength. The color compensating film reduces or adjusts the amounts of Red/Green/Yellow lights to change or correct color balance.

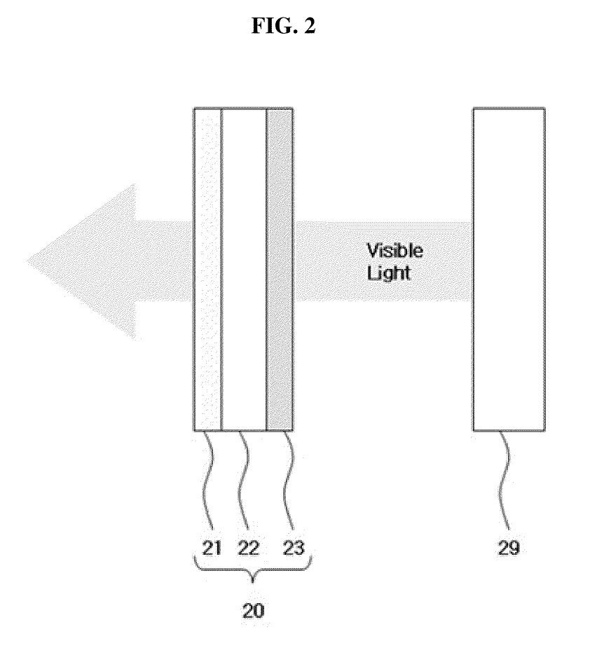

FIG. 2 is a cross sectional view illustrating a second display device with a display filter according to a second embodiment of the present invention. Here, the second display device illustrated in FIG. 2 may be an LCD (liquid crystal display) device.

Referring to FIG. 2, the display filter 20 used for the LCD device is disposed in front of a display module 29. The display filter 20 of the present invention includes an indoor air purification layer 21, an anti-reflection film 22, and a base substrate 23.

Although the present invention has been described with respect to a PDP (Plasma Display Panel) device and an LCD (liquid crystal display) device as an example for convenience's sake, this is not intended to limit the present invention. The present invention is applicable to a variety of display devices such as an OELD (Organic Electro luminescent Display) device and so on.

It will be apparent to those skilled in the art that various modifications and variations can be made in the practice of the present invention and in construction of the system of the invention without departing from the scope or spirit of the invention. Other embodiments of the invention will be apparent to those skilled in the art from consideration of the specification and practice of the invention. Thus, it is intended that the specification and examples be considered as exemplary only, with a true scope and spirit of the invention being indicated by the following claims.

What is claimed is:

1. A display filter for a display device having a display module, the display filter comprising:
a base substrate disposed in front of the display module;
at least one optical filter layer layered on the base substrate; and
an indoor air purification layer layered on an outwardly exposed side of the display filter and removing indoor air pollutants.

2. The display filter of claim 1, wherein the indoor air purification layer comprises a photocatalyst compound.

3. The display filter of claim 2, wherein the photocatalyst compound comprises at least one of titanium oxide, zinc oxide, cadmium sulfide, zirconium oxide, tin oxide, vanadium oxide, tungsten trioxide, and strontium titanate.

4. The display filter of claim 2, wherein the indoor air purification layer further comprises an adsorbent which adsorbs toxic or malodorous pollutants in the atmosphere.

5. The display filter of claim 4, wherein the adsorbent comprises at least one of activated carbon and zeolite.

6. The display filter of claim 2, wherein the indoor air purification layer further comprises an antimicrobial material which destroys harmful microbes.

7. A display device comprising:
the display filter recited in claim 1.
